(19) United States
(12) Patent Application Publication
(10) Pub. No.: US 2026/0073019 A1
(43) Pub. Date: Mar. 12, 2026

(54) CLUSTERING APPARATUS, METHOD, AND STORAGE MEDIUM

(71) Applicant: KABUSHIKI KAISHA TOSHIBA, Kawasaki-shi Kanagawa (JP)

(72) Inventors: Yasutaka FURUSHO, Fuchu Tokyo (JP); Shuhei NITTA, Tokyo (JP)

(73) Assignee: KABUSHIKI KAISHA TOSHIBA, Kawasaki-shi Kanagawa (JP)

(21) Appl. No.: 19/311,760

(22) Filed: Aug. 27, 2025

(30) Foreign Application Priority Data
Sep. 10, 2024 (JP) 2024-156631

(51) Int. Cl. G06F 18/232; G06F 16/28

(52) U.S. Cl. CPC G06F 18/232; G06F 16/285

(57) ABSTRACT

According to one embodiment, a clustering apparatus includes processing circuitry. The processing circuitry is configured to: acquire input data; calculate a feature vector from the input data; divide the input data into two or more clusters based on the feature vector; select a first cluster from the two or more clusters; select a second cluster different from the first cluster from the two or more clusters; extract target data from the input data; calculate a degree of cluster classification indicating an index by which the target data is classified into the first cluster or the second cluster based on the target data, the first cluster, and the second cluster; and convert the target data based on the degree of cluster classification.

### CROSS-REFERENCE TO RELATED APPLICATION

This application is based upon and claims the benefit of priority from Japanese Patent Application No. 2024-156631, filed Sep. 10, 2024, the entire contents of which are incorporated herein by reference.

### FIELD

Embodiments described herein relate generally to a clustering apparatus, a method, and a storage medium.

### BACKGROUND

A clustering apparatus that divides input data, which is a vector data group, into a plurality of clusters and outputs an obtained clustering result is known. The user can understand contents of different clusters by interpreting such a clustering result. The content of different clusters is, for example, differences in input data for distinguishing the individual clusters.

The clustering apparatus as described above usually has no particular problem, but there is room for improvement according to the study of the present inventors in that it may be difficult to interpret the clustering result. For example, upon attempt of interpretation of a clustering result, there is a case where it is desired to find out differences among pieces of input data that belong to different clusters but are similar and indistinguishable. However, in a case of complex input data, specialized knowledge is required to find a difference in input data between different clusters, and it is difficult for a common user to interpret a clustering result. Therefore, according to the study of the present inventor, a technology capable of assisting the interpretation of the clustering result is desired.

Here, although not applicable to clustering results, the background art related to visualization of class classification as follows is known. In this background art, class likeness of a specific class of a class classifier is visualized. Specifically, in this background art, data in which a classification degree corresponding to a specific class of a class classifier is maximized (activation maximization) and a region in which a classification degree greatly changes by perturbation applied to input data (sensitivity map) are output. However, as described above, this background art is a technology related to visualization of class classification, and cannot be applied to a clustering result. In addition, if the data of the original two classes is similar, the data generated for the original two classes is also similar and indistinguishable, and thus, this background art cannot be applied to a technology for assisting interpretation of a clustering result.

### BRIEF DESCRIPTION OF DRAWINGS

FIG. 1 is a block diagram illustrating an example of a configuration of a clustering apparatus according to a first embodiment.

FIG. 2 is a flowchart in explanation of an operation of the first embodiment.

FIG. 3 is a schematic diagram in explanation of input data according to the first embodiment.

FIG. 4 is a schematic diagram illustrating an example of a scatter diagram according to the first embodiment.

FIG. 5 is a schematic diagram in explanation of a degree of cluster classification according to the first embodiment.

FIG. 6 is a schematic diagram in explanation of a degree of cluster classification according to a modification of the first embodiment.

FIG. 7 is a schematic diagram in explanation of an element of target data according to a modification of the first embodiment.

FIG. 8 is a schematic diagram in explanation of an element of target data according to a modification of the first embodiment.

FIG. 9 is a block diagram illustrating an example of a configuration of a clustering apparatus according to a second embodiment.

FIG. 10 is a schematic diagram in explanation of an image with emphasis on pattern according to the second embodiment.

FIG. 11 is a schematic diagram in explanation of an image with emphasis on pattern according to the second embodiment.

FIG. 12 is a block diagram illustrating an example of a hardware configuration of a clustering apparatus according to a third embodiment.

### DETAILED DESCRIPTION

In general, according to one embodiment, a clustering apparatus includes processing circuitry. The processing circuitry is configured to acquire input data. The processing circuitry is configured to calculate a feature vector from the input data. The processing circuitry is configured to divide the input data into two or more clusters based on the feature vector. The processing circuitry is configured to select a first cluster from the two or more clusters. The processing circuitry is configured to select a second cluster different from the first cluster from the two or more clusters. The processing circuitry is configured to extract target data from the input data; calculate a degree of cluster classification indicating an index by which the target data is classified into the first cluster or the second cluster based on the target data, the first cluster, and the second cluster; and convert the target data based on the degree of cluster classification.

Hereinafter, embodiments will be exemplarily described with reference to the drawings. In the following description, image (hereinafter, referred to as a SEM image) data obtained by photographing a silicon nitride substrate with a scanning electron microscope or the like is used as an example of the input data. The SEM image may be referred to as a SEM picture. The input data is not limited to image data such as the SEM image.

### First Embodiment

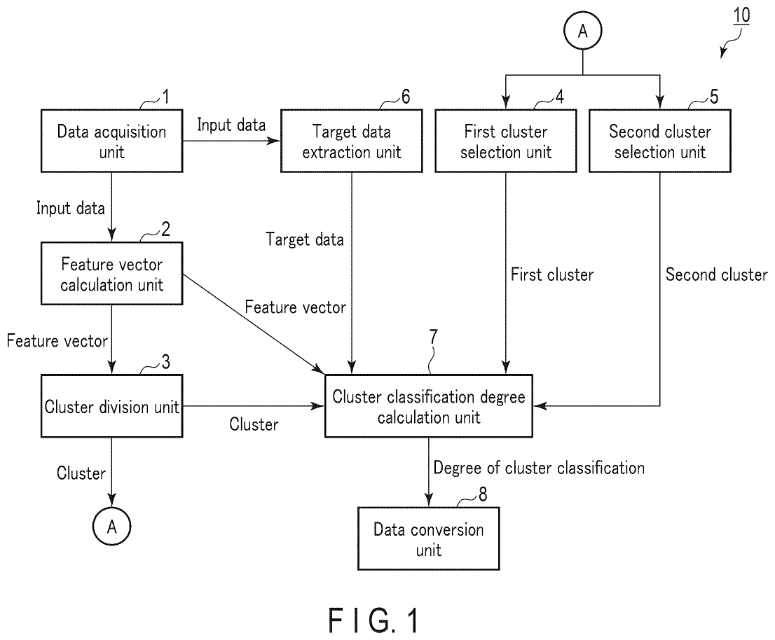

FIG. 1 is a block diagram illustrating an example of a configuration of a clustering apparatus according to a first embodiment. A clustering apparatus 10 includes a data acquisition unit 1, a feature vector calculation unit 2, a cluster division unit 3, a first cluster selection unit 4, a second cluster selection unit 5, a target data extraction unit 6, a cluster classification degree calculation unit 7, and a data conversion unit 8. Since this clustering apparatus can be variously modified, it is assumed that data obtained in each unit on the upstream side can be used in each unit on the downstream side regardless of the presence or absence of an arrow connecting the units.

Here, the data acquisition unit 1 acquires input data from an external device or a memory (not illustrated) of the own device. The input data is a data group before clustering is performed.

The feature vector calculation unit 2 calculates a feature vector from the acquired input data.

The cluster division unit 3 divides the input data into two or more clusters based on the calculated feature vector. Note that the cluster division unit 3 may be referred to as a clustering unit. The two or more clusters obtained by the division may be referred to as a clustering result.

The first cluster selection unit 4 selects a first cluster from the two or more clusters.

The second cluster selection unit 5 selects a second cluster different from the first cluster from the two or more clusters.

The target data extraction unit 6 extracts target data from the acquired input data. For example, the target data extraction unit 6 may extract the target data by combining pieces of the input data of the first cluster and the second cluster. As a combination method, for example, two pieces of the input data extracted respectively from the first cluster and the second cluster may be averaged.

Based on the target data, the first cluster, and the second cluster, the cluster classification degree calculation unit 7 calculates a degree of cluster classification indicating an index by which the target data is classified into the first cluster or the second cluster. For example, the degree of cluster classification represents a degree by which the target data belongs to the first cluster or the second cluster. Specifically, for example, the degree of cluster classification may represent projection of the target data onto a direction vector from a representative vector of the first cluster to a representative vector of the second cluster. For example, the representative vector of the first cluster may be an average of feature vectors of the input data belonging to the first cluster. Similarly, for example, the representative vector of the second cluster may be an average of feature vectors of the input data belonging to the second cluster.

The data conversion unit 8 converts the target data based on the degree of cluster classification. For example, the data conversion unit 8 may convert the target data to increase and/or decrease the degree of cluster classification. Specifically, for example, in a case where the target data is converted to increase the degree of cluster classification, the data conversion unit 8 may iteratively add a differential of the degree of cluster classification with respect to the target data to the target data. In addition, for example, in a case where the target data is converted to decrease the degree of cluster classification, the data conversion unit 8 may iteratively subtract a differential of the degree of cluster classification with respect to the target data from the target data.

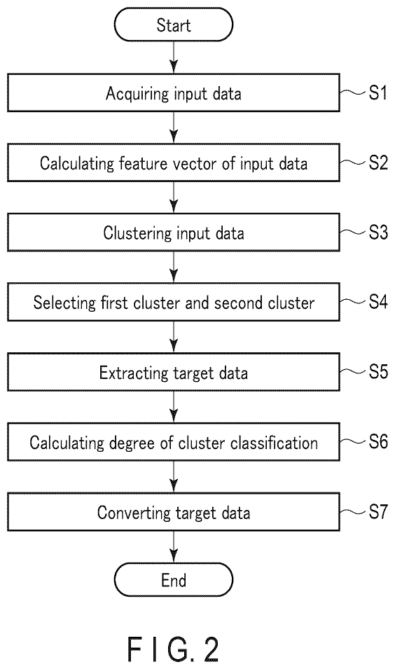

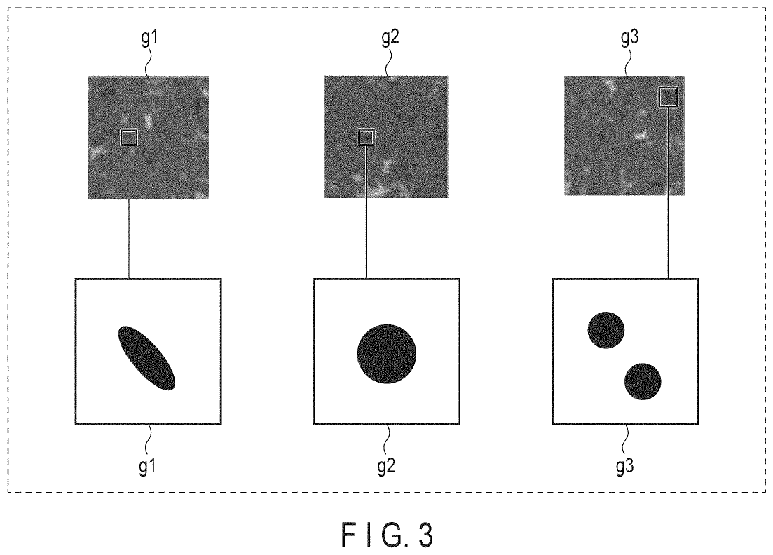

Next, an operation of the clustering apparatus configured as described above will be described with reference to a flowchart of FIG. 2 and schematic diagrams of FIGS. 3 to 5.

### (Step S1: Acquiring Input Data)

The data acquisition unit 1 acquires input data to which clustering is to be performed. Here, the input data is a group of SEM images of the silicon nitride substrate, and actual data pieces g1 to g3 are illustrated in the upper part of FIG. 3, and schematic data pieces g1 to g3 for facilitating understanding are illustrated in the lower part. For example, an elongated black mark which is a material texture pattern of the SEM image represented by the upper data piece g1 is represented as a black ellipse in the lower data piece g1. Similarly, a substantially circular black mark represented by the upper data piece g2 is represented as a black circle in the lower data piece g2. Similarly, closely positioned substantially circular black marks represented by the upper data piece g3 is represented as closely positioned black circles in the lower data piece g3. As illustrated in the upper part of FIG. 3, the pieces of the input data are black-and-white images each having an image size of 32×32 pixels. That is, the input data is a vector data group×∈R¹⁰²⁴ of a 1024 dimensional vector of 32×32. Note that the image size, dimension, and the like of the input data are examples, and are not limited thereto. The input data is not limited to the black-and-white image, and may be a color image (RGB value) having dimensions three times greater than the dimensions of the black-and-white image.

### (Step S2: Calculating Feature Vector)

The feature vector calculation unit 2 calculates a feature vector from the input data. For example, the feature vector calculation unit 2 calculates a feature vector from the input data using a deep neural network (DNN) or the like as a feature extractor. Specifically, for example, the feature vector calculation unit 2 uses a neural network Φ: R¹⁰²⁴-R¹²⁸ that outputs a 1024 dimensional feature vector based on input data of the input 128 dimensional vector. Note that the dimensions of the feature vector is an example, and is not limited thereto.

### (Step S3: Clustering)

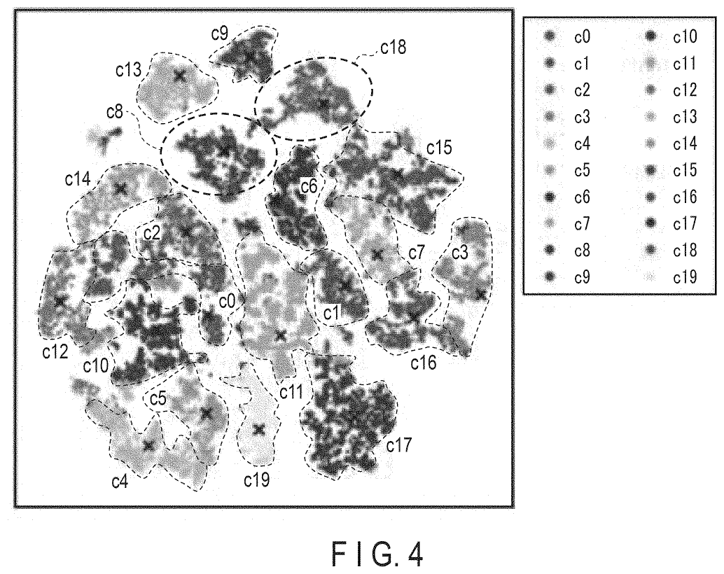

The cluster division unit 3 performs clustering of the input data based on the feature vector, and divides the input data into two or more clusters. In the present embodiment, cluster division of a 128 dimensional feature vector is performed using k-means. In addition, the cluster division unit 3 converts a 128 dimensional feature vector into a two-dimensional vector by t-Distributed Stochastic Neighbor Embedding (t-SNE). FIG. 4 illustrates a scatter diagram in which the two-dimensional vector is represented by points. In this scatter diagram, two-dimensional vectors are arranged at coordinate points indicated by different first and second components. In addition, this scatter diagram illustrates a clustering result obtained by dividing a two-dimensional vector group into 20 clusters c0 to c19 and color-coding the clusters. However, differences between the clusters are not clear from the colors of the clusters.

Note that, as the clustering method, for example, various methods such as a centroid method and kernel density estimation can be applied in addition to k-means. In addition, in FIG. 4, the number of clusters is set to 20, but is not limited thereto. A numerical value of the number of clusters may be set by the user with reference to the scatter diagram of feature vectors in a dimensionally compressed space using a method such as principal component analysis (PCA), uniform manifold approximation and projection (UMAP), or t-SNE. In addition, the numerical value of the number of clusters may be determined using an existing algorithm that automatically estimates the number of clusters.

### (Step S4: Selecting Each Cluster)

The first cluster selection unit 4 selects a first cluster from two or more clusters. Similarly, the second cluster selection unit 5 selects a second cluster from the two or more clusters. To supplement, in step S4, from the 20 clusters c0 to c19 included in the clustering result, two clusters c8 and c18 for which a difference is to be clarified are selected as the first cluster and the second cluster. The clusters c8 and c18 are adjacent in the scatter diagram and have similar material tissue patterns. However, other than a pair of adjacent clusters on the scatter diagram, any pair of clusters can be selected as long as it is a pair of clusters for which a difference is to be clarified.

Note that the clusters c8 and c18 are essentially different in aspect ratios of the black marks, and the cluster c8 has more elongated black mark. Note that the aspect ratio of the black mark can be measured as, for example, a ratio of a width and a height of a rectangle surrounding the black mark. However, such a pattern of the black mark is overlooked by the user at the time of step S4 because other patterns are intricate in the SEM image.

The pattern of the black mark clearly indicates where there is a difference between the two clusters by converting only the aspect ratio of the black mark, which is an essential difference between the two clusters c8 and c18, into the aspect ratio unique to each cluster by step S7 to be described later.

### (Step S5: Extracting Target Data)

The target data extraction unit 6 extracts the target data from the input data. For example, the target data extraction unit 6 sets an average of the two pieces of input data respectively extracted from the first cluster and the second cluster as the target data. Note that the target data is converted into two pieces of data in which respective patterns unique to the first cluster and the second cluster are emphasized in step S7 described later. In addition, the converted pieces of data are compared with each other to clarify a difference between the two clusters. Therefore, as the target data, it is preferable to select target data that serves as a reference of the two pieces of data after conversion and has no bias for comparison. For example, the target data may be all the input data belonging to the two clusters, or may be an average of subsets of all the input data.

### (Step S6: Calculating Degree of Cluster Classification)

Based on the target data, the first cluster, and the second cluster, the cluster classification degree calculation unit 7 calculates a degree of cluster classification indicating an index by which the target data is classified into the first cluster or the second cluster. The degree of cluster classification may be, for example, a projection of a feature vector Φ(x₀) of target data x₀ onto the direction vector from a representative vector Φ1 of the first cluster to a representative vector Φ2 of the second cluster as shown in Expression (1). In Expression (1), (.) T represents transposition.

Proj(Φ(x₀))=(Φ(x₀)−Φ2)^{T}(Φ1−Φ2) (1)

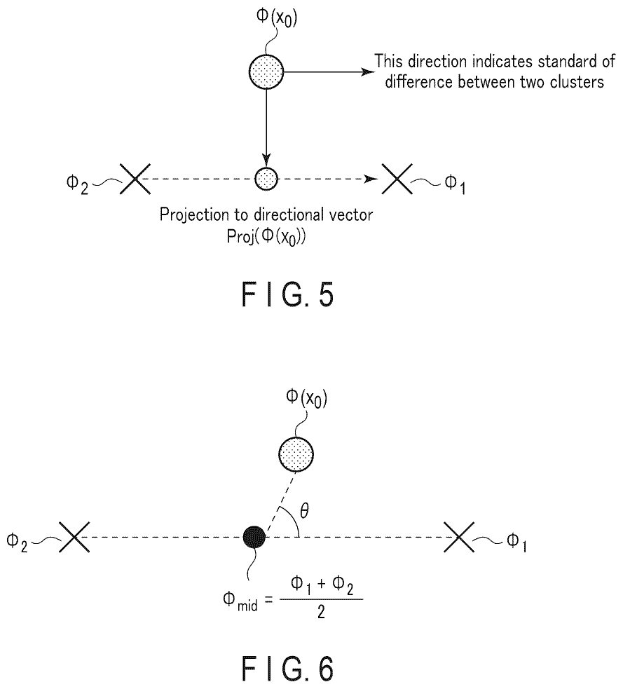

As illustrated in FIG. 5, a larger scalar value of the degree of cluster classification means that the target data belongs to the first cluster, and a smaller scalar value of the degree of cluster classification means that the target data belongs to the second cluster. To supplement, in FIG. 5, the degree of cluster classification is calculated as a value on an axis between the representative vectors Φ1 and Φ2 of the first cluster and the second cluster of the target data x₀. An axial direction represented by an axis connecting the representative vectors Φ1 and Φ2 of the two clusters is a direction of a feature vector representing a difference between the two clusters. If the feature vector (representations of the target data) is moved only in this direction, the target data is converted into data that emphasizes the difference between the two clusters. An element of the target data (and the input data) corresponding to this direction is an important element for emphasizing the difference between the two clusters.

In addition, the representative vectors of the first cluster and the second cluster were set as averages of the feature vectors of all the input data belonging to the respective clusters. However, the representative vector is not limited thereto, and may be a feature vector of each cluster closest to the average of the feature vectors. In addition, the representative vector may be an average of feature vectors of subsets of all input data belonging to each cluster.

### (Step S7: Converting Target Data)

The data conversion unit 8 converts the target data to increase and/or decrease the degree of cluster classification. For example, in a case where the target data is converted to increase the degree of cluster classification, the data conversion unit 8 may iteratively add a differential of the degree of cluster classification with respect to the target data x to the target data x. Specifically, for example, as shown in Expression (2), the data conversion unit 8 iteratively converts the target data x₀ by a gradient ascent method to increase the degree of cluster classification into data xr in which a pattern specific to the first cluster is emphasized as compared to the second cluster. The subscript “T” of the target data x represents a predetermined number of iterations of the gradient ascent method. In Expression (2), the subscript “t+1” of the target data x represents the latest number of iterations of the gradient ascent method. The upper limit of the latest number of iterations “t+1” is a predetermined number of iterations “T”.

cₜ₊₁=xₜ+η∇ₓProj(Φ(xₜ)) (2)

Here, η is a learning rate. In addition, ∇ₓProj (Φ(xₜ)) is a gradient vector of the degree of cluster classification with respect to the target data x. The gradient vector ∇ₓProj(Φ(xₜ)) is a movement direction from the target data x in which the degree of cluster classification increases, that is, the target data x is guided to be classified into the first cluster instead of the second cluster. and by moving the target data x in the movement direction, a pattern specific to the first cluster is emphasized as compared to the second cluster.

Conversely, in a case where the target data x is converted to decrease the degree of cluster classification, the data conversion unit 8 may iteratively subtract a differential of the degree of cluster classification with respect to the target data x from the target data x. Specifically, for example, as shown in Expression (3), the data conversion unit 8 iteratively converts the target data x₀ in the opposite direction of the gradient by the gradient descent method to decrease the degree of cluster classification into data x_{T} in which a pattern specific to the second cluster compared to the first cluster is emphasized.

xₜ₊₁=xₜ−η∇ₓProj(Φ(xₜ)) (3)

In this manner, the data conversion unit 8 can emphasize the pattern specific to the first cluster compared to the second cluster by converting the target data to increase the degree of cluster classification. At this time, the data converted to increase the degree of cluster classification has a feature vector close to the representative value of the first cluster and far from the representative value of the second cluster.

In addition, the data conversion unit 8 can emphasize a pattern specific to the second cluster compared to the first cluster by converting the target data to decrease the degree of cluster classification. Similarly, the data converted to decrease the degree of cluster classification has a feature vector far from the representative value of the first cluster and close to the representative value of the second cluster.

In any case, since a cluster-specific pattern is emphasized in the converted data, it is possible to assist interpretation of the clustering result.

As described above, according to the first embodiment, the data acquisition unit 1 acquires the input data. The feature vector calculation unit 2 calculates a feature vector from the input data. The cluster division unit 3 divides the input data into two or more clusters based on the feature vector. The first cluster selection unit 4 selects a first cluster from two or more clusters. The second cluster selection unit 5 selects the second cluster different from the first cluster from the two or more clusters. The target data extraction unit 6 extracts the target data from the input data. Based on the target data, the first cluster, and the second cluster, the cluster classification degree calculation unit 7 calculates a degree of cluster classification indicating an index by which the target data is classified into the first cluster or the second cluster. The data conversion unit 8 converts the target data based on the degree of cluster classification. As described above, the interpretation of the clustering result can be assisted by the configuration in which the first cluster and the second cluster are selected from the two or more clusters and the target data is converted based on the degree of cluster classification indicating the index in which the target data is classified into the first cluster or the second cluster.

For example, in the first embodiment, in order to clarify a difference between two clusters having input data that are indistinguishably similar, a difference narrowed down to the two clusters among all the clusters is quantified as a degree of cluster classification. Thereafter, the target data is converted to emphasize a specific pattern obtained by comparing the target data with the other of the clusters based on the degree of cluster classification. The difference between the two clusters can be clarified by comparing the data to which the conversion relating to the classification of both clusters is applied.

In addition, according to the first embodiment, the target data extraction unit 6 extracts the target data by combining pieces of the input data respectively of the first cluster and the second cluster. In this case, in addition to the effects described above, with the configuration of extracting pieces of the target data respectively related to the first cluster and the second cluster, it is possible to more clearly indicate where there is a difference between both clusters in the data obtained by converting the target data.

In addition, according to the first embodiment, the degree of cluster classification represents projection of the target data onto the direction vector from the representative vector of the first cluster to the representative vector of the second cluster. In this case, in addition to the effects described above, it can be quantitatively indicated that the target data belongs to the first cluster as the value on the axis between the representative vector of the first cluster and the representative vector of the second cluster is larger, and that the target data belongs to the second cluster as the value is smaller.

According to the first embodiment, the representative vector of the first cluster is an average of the feature vectors of the input data belonging to the first cluster. The representative vector of the second cluster is an average of the feature vectors of the input data belonging to the second cluster. In this case, in addition to the effects described above, since the representative vector reflecting all the input data belonging to each cluster is used for calculation of the degree of cluster classification, all the input data belonging to the corresponding cluster can be reflected in the degree of cluster classification.

Furthermore, according to the first embodiment, the data conversion unit 8 converts the target data to increase and/or decrease the degree of cluster classification. In this case, in addition to the effects described above, the target data can be converted to change a magnitude of the degree of cluster classification.

In addition, according to the first embodiment, in a case where the target data is converted to increase the degree of cluster classification, the data conversion unit 8 iteratively adds a differential of the degree of cluster classification with respect to the target data to the target data. In a case where the target data is converted to decrease the degree of cluster classification, the data conversion unit 8 iteratively subtracts a differential of the degree of cluster classification with respect to the target data from the target data. In this case, in addition to the effects described above, the target data can be changed stepwise to change the magnitude of the degree of cluster classification.

### Modifications of First Embodiment

Next, some modifications of the first embodiment will be described. The modifications can be combined with each other, and are similarly applicable to the following embodiments.

### <Modification Regarding Input Data>

In the first embodiment, the image data such as the SEM image is applied to the input data, but is not limited thereto, and can be applied to any input data to be clustered. For example, arbitrary data such as time-series data, audio data, text data, or moving image data can be applied as the input data. Note that the time-series data is time-series data other than audio data and moving image data, and for example, center data collected from a sensor operating in a factory or the like can be used. As described above, even in the modification using the input data other than the image data, the same operation and effect as those of the first embodiment can be obtained.

In addition, according to this modification, since the interpretation of the clustering result of any type of input data can be assisted, an analysis result of the clustering result according to the type of input data can be obtained. Further, for example, by obtaining the analysis result of the clustering result, it can be expected to generate value according to the type of input data. For example, by obtaining an analysis result that clarifies a difference between two clusters of a non-defective product and a defective product whose difference is not clear among clustering results of sensor data regarding a manufacturing process of a factory, it can be expected that value such as improvement of the manufacturing process and improvement of a yield is generated.

### <Modification Regarding Feature Extractor>

In the first embodiment, in the feature vector calculation unit 2, a neural network such as a DNN is used as a feature extractor, but is not limited thereto, and an arbitrary function that outputs a two-dimensional or more vector having input data as an input can be applied to the feature extractor. For example, linear mapping learned from data such as PCA, UMAP, and Fisher Discriminant Analysis (FDA) can be applied as an arbitrary function. In addition, a human-designed function may be applied as the arbitrary function. As the function, Haar-Like representations, Histogram of Oriented Gradients (HoG) representations, Scale-invariant Feature Transform (SIFT) representations, or the like can be applied in a case where the image is taken as an example of input data. As described above, even in a modification in which the feature vector calculation unit 2 uses a feature extractor other than the neural network, it is possible to obtain the same operational effects as those of the first embodiment.

### <Modification Regarding Target Data Extraction Unit 6>

In the first embodiment, the target data extraction unit 6 extracts the target data by combining the input data of each of the first cluster and the second cluster, but is not limited thereto. For example, the target data extraction unit 6 may extract the target data by performing selection from or combination of the input data. According to such a modification, similarly to the above, it is possible to assist interpretation of the clustering result.

Furthermore, for example, the target data extraction unit 6 may extract the target data by performing selection from or combination of the input data of the first cluster or the second cluster. As a combination method, for example, an average of all input data belonging to a cluster to be selected or combined may be used, or an average of subsets of all input data may be used. According to such a modification, in addition to the effects described above, with the configuration of extracting the target data related to the cluster, it is possible to clearly indicate the feature of the cluster in the data obtained by converting the target data.

### <Modification Regarding Degree of Cluster Classification>

The degree of cluster classification is not limited to projection onto a direction vector, and a scalar value for classifying arbitrary first and second clusters can be used. For example, the degree of cluster classification may represent a difference between a distance of the representative vector of the first cluster from the target data and a distance of the representative vector of the second cluster from the target data. Specifically, as shown in Expression (4), for example, the degree of cluster classification may be a difference between a distance to the representative vector Φ₁ of the first cluster from the feature vector Φ(x₀) of the target data x₀ and a distance to the representative vector Φ2 of the second cluster from the feature vector Φ(x₀) of the target data x₀.

d(Φ(x₀),Φ₂)−d(Φ(x₀),Φ₁) (4)

Here, d is an arbitrary distance function (Euclidean distance, L1 distance, or the like).

Even with such a modification, the same effects as those of the first embodiment can be obtained.

In addition, the degree of cluster classification may represent a cosine of an angle between the feature vector Φ(x) of the target data x and the representative vector Φ₁ of the first cluster with a midpoint Φmid between the representative vector Φ₁ of the first cluster and the representative vector Φ₂ of the second cluster as an origin. Specifically, for example, as illustrated in FIG. 6 and Expression (5), the degree of cluster classification may be a cosine of an angle from the first cluster to the second cluster taking a midpoint Pmid Of the representative vectors Φ₁ and Φ₂ of the first cluster and the second cluster as a central axis. In Expression (5), (·)^{T} represents transposition, and ∥·∥ represents an L2 norm. Further, Φ_{mid} is expressed by Expression (6).

$$cos θ ( ϕ ( x ) ) = \frac{{( ϕ ( x ) - {ϕ}_{mid} )}^{T} ( {ϕ}_{1} - {ϕ}_{mid} )}{‖ ϕ ( x ) - {ϕ}_{mid} ‖ \cdot ‖ {ϕ}_{1} - {ϕ}_{mid} ‖} \qquad ( 5 )$$

$${ϕ}_{mid} = \frac{{ϕ}_{1} + {ϕ}_{2}}{2} \qquad ( 6 )$$

Even with such a modification, the same effects as those of the first embodiment can be obtained.

### <Modification Regarding Representative Vector>

In the first embodiment, the representative vector of the first cluster is an average of the feature vectors of the input data belonging to the first cluster, and the representative vector of the second cluster is an average of the feature vectors of the input data belonging to the second cluster, but is not limited thereto. For example, the representative vector of the first cluster may be an average of feature vectors of subsets of the input data belonging to the first cluster. The representative vector of the second cluster may be an average of feature vectors of subsets of the input data belonging to the second cluster. According to such a modification, with the configuration in which the number of feature vectors used for average calculation is reduced, it is possible to reduce a load for calculating the representative vector in addition to the effect of the first embodiment.

In addition, for example, the representative vector of the first cluster may be a feature vector of input data closest to the average of the first clusters. The representative vector of the second cluster may be a feature vector of input data closest to the average of the second cluster. According to such a modification, with the configuration in which the feature vector of the input data closest to the average of the clusters is used as the representative vector, it is possible to reduce a load for calculating the representative vector in addition to the effect of the first embodiment.

### <Modification of Data Conversion Method>

In the first embodiment, the gradient ascent method and the gradient descent method are used upon conversion of the target data, but is not limited thereto. For example, the data conversion unit 8 may use a method such as a genetic algorithm including selection and mutation the target data is converted. Specifically, for example, the data conversion unit 8 may perform: (a) processing of randomly converting the target data to create a plurality of pieces of data; (b) processing of randomly converting, among the plurality of pieces of data, data having a large degree of cluster classification and data having a small degree of cluster classification to create a plurality of pieces of data; and (c) processing of converting the target data by recursively repeating the processing (b). The repetition of the processing (c) may end upon completion of an end condition. The end condition may be, for example, a condition that the processing is repeated for a reference number of times. In addition, for example, the end condition may be a condition that the degree of cluster classification in data having a large degree of cluster classification among the plurality of pieces of generated data is larger than a first threshold value. In addition, for example, the end condition may be a condition that the degree of cluster classification in data having a small degree of cluster classification among the plurality of pieces of generated data is smaller than a second threshold value. Even in such a modification, since the target data can be converted to emphasize the cluster-specific pattern, the same effect as the effect of the first embodiment can be obtained.

### <Modification of Data to be Converted>

In the first embodiment, the target data is converted to emphasize the cluster-specific pattern, but is not limited thereto. For example, the data conversion unit 8 may output an element of the target data in which the degree of cluster classification greatly changes in a case where the target data is perturbed. Specifically, for example, the data conversion unit 8 may output the size (absolute value or square value) of each element of the gradient vector of the degree of cluster classification with respect to the target data.

Furthermore, for example, the data conversion unit 8 may output the size (absolute value or square value) of each element of the gradient vector of the degree of cluster classification and the difference between adjacent elements of the target data with respect to the target data.

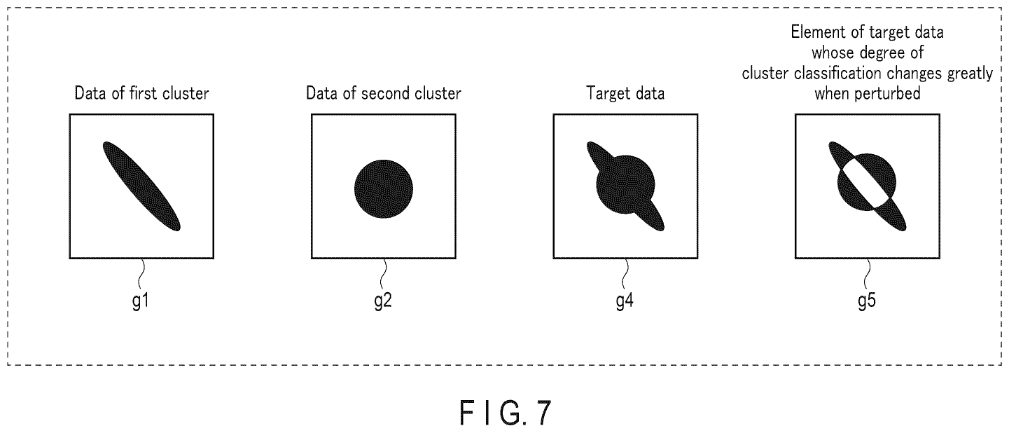

FIG. 7 is a schematic diagram in explanation of the elements of the target data, and schematically illustrates an example of the data piece g1 of the first cluster, the data piece g2 of the second cluster, a target data piece g4 based on the data pieces g1 and g2, and an element g5 of the target data reacting to the perturbation. In FIG. 7, upon perturbation to a direction in which the upper left and lower right semi-elliptical portions (elliptical portions) indicated by the element g5 of the target data are emphasized, the degree of cluster classification greatly changes so that the target data is classified into the first cluster. In addition, upon perturbation to emphasize the upper right and lower left approximately semicircular portions (approximately semicircular portions) in the element g5 of the target data, the degree of cluster classification greatly changes so that the target data is classified into the second cluster. The element g5 of such target data represents a difference between the first cluster and the second cluster.

Therefore, according to this modification, in addition to the effect of the first embodiment, it is possible to output the element of the target data representing the difference between the first cluster and the second cluster and the size of the element.

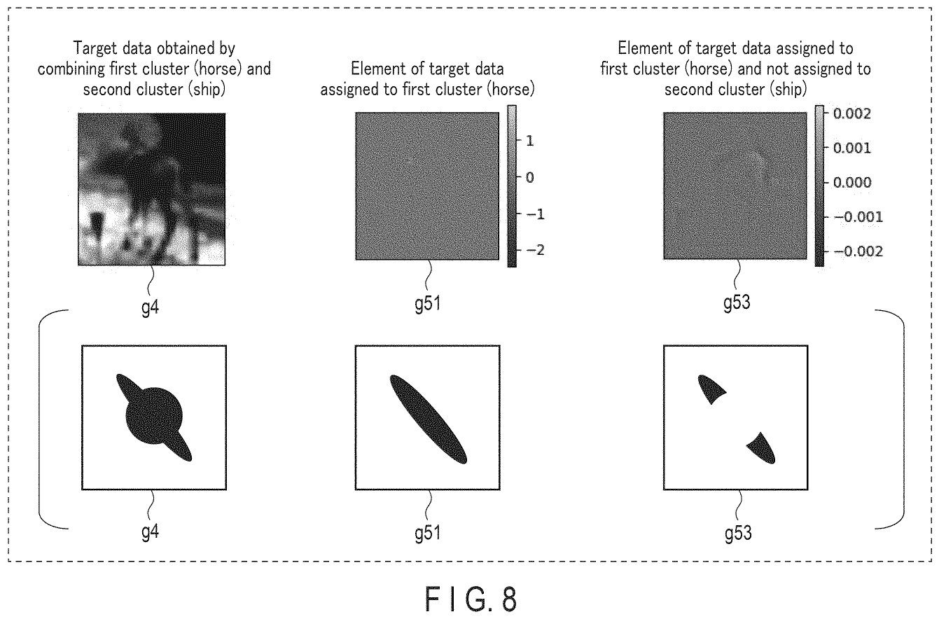

FIG. 8 is a schematic diagram in explanation of elements of target data extracted from input data classified as a horse or a ship, and actual data is illustrated in the upper part and schematic data for facilitating understanding is illustrated in the lower part. In the schematic data in the lower row, a substantially elliptical shape corresponds to a horse, and a substantially circular shape corresponds to a ship. In FIG. 8, the upper left part represents the target data piece g4 obtained by combining pieces of the input data respectively of the first cluster (horse) and the second cluster (ship). The upper middle row represents an element g51 of the target data to be allocated to the first cluster (horse). The upper right part represents an element g53 of the target data allocated to the first cluster (horse) and not allocated to the second cluster. In the example illustrated in the upper part of FIG. 8, out of the element g51 of the target data related to the first cluster (horse) and the element (not illustrated) of the target data related to the second cluster (ship), the element g53 (horse contour) of the target data related to only the first cluster (horse) is output. As described above, in the case of outputting the element of the target data related to only the first cluster of the two clusters, it is possible to clarify that the element (horse contour) related to only the first cluster is important as the element to be guided to be classified into the first cluster. Note that the importance mentioned here means that the degree of cluster classification greatly changes upon perturbation.

Therefore, according to this modification, in addition to the effect of the first embodiment, it is possible to output the element of the target data more clearly representing the difference between the first cluster and the second cluster and the size of the element.

### Second Embodiment

Next, a clustering apparatus according to a second embodiment will be described.

The second embodiment is a modification of the first embodiment, and is a mode of displaying data obtained by converting target data.

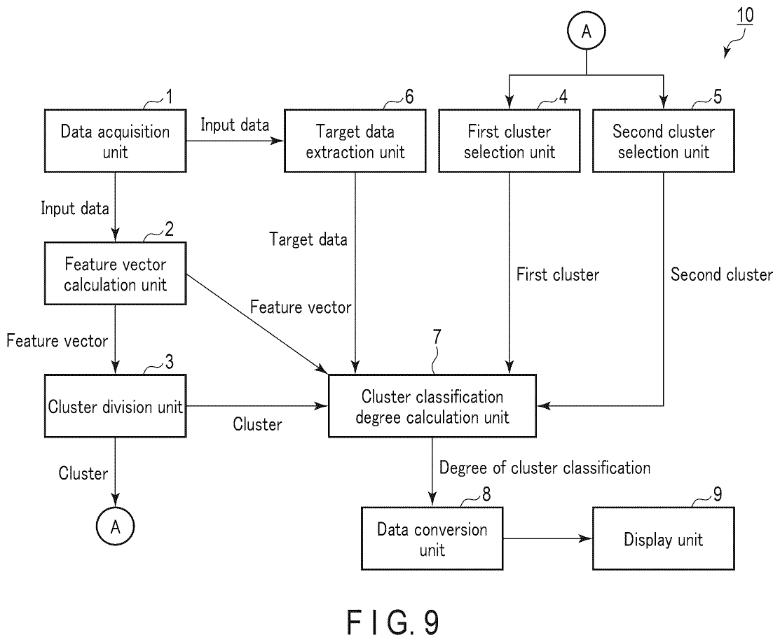

FIG. 9 is a block diagram illustrating an example of a configuration of the clustering apparatus according to the second embodiment, and components that are the same as the components described above are denoted by the same reference numerals, and detailed description thereof is omitted, and different portions will be mainly described. In the following embodiments, redundant description is similarly omitted. The clustering apparatus 10 here further includes a display unit 9 as compared with the configuration illustrated in FIG. 1.

Here, the display unit 9 displays the target data, data (first correction data) obtained by converting the target data to increase the degree of cluster classification, and data (second correction data) obtained by converting the target data to decrease the degree of cluster classification. In the present embodiment, the display unit 9 displays the target data, the first correction data, and the second correction data side by side. However, not limited thereto, the display unit 9 may selectively display any one or two of the target data, the first correction data, and the second correction data according to the user's operation.

Other configurations are the same as those in the first embodiment.

According to the above configuration, the clustering apparatus 10 executes steps S1 to S7 in the same manner as described above, and converts the target data based on the degree of cluster classification.

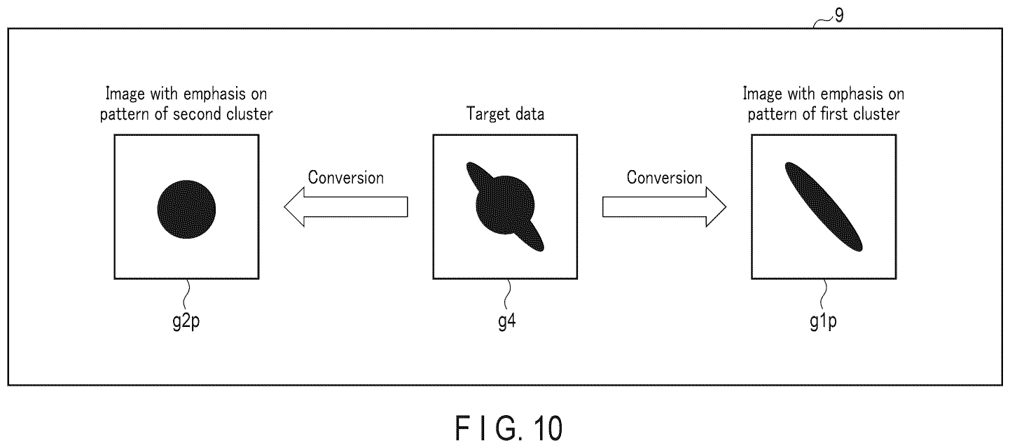

After step S7, for example, as illustrated in FIG. 10, the display unit 9 displays such that the target data piece g4 is arranged at the center, a pattern-emphasized image g1p of the first cluster is arranged on the right side, and a pattern-emphasized image g2p of the second cluster is arranged on the left side. Note that the pattern-emphasized image g1p of the first cluster is an example of the first correction data obtained by converting the target data piece g4 to increase the degree of cluster classification. The pattern-emphasized image g2p of the second cluster is an example of the second correction data obtained by converting the target data piece g4 to decrease the degree of cluster classification. That is, the display unit 9 arranges and displays the pattern-emphasized image g1p of the first cluster, the target data piece g4, and the pattern-emphasized image g2p of the second cluster in the order of the degree of cluster classification.

In this manner, the display unit 9 can assist the interpretation of the clustering result by facilitating the understanding of a pattern specific to each cluster through the display of the pattern-emphasized images g1p and g2p.

### Modifications of Second Embodiment

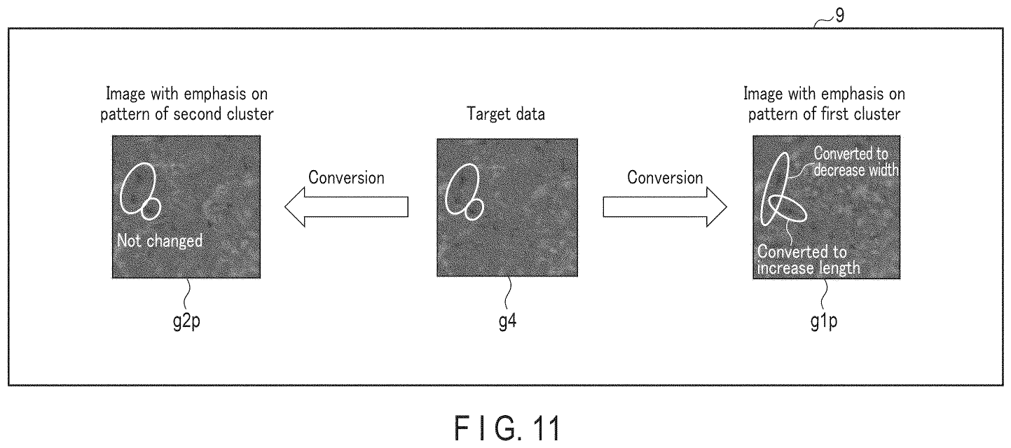

In the second embodiment, as schematically illustrated in FIG. 10, the pattern-emphasized images g1p and g2p of the corresponding clusters greatly change from the target data piece g4, but is not limited thereto. For example, regarding the actual SEM image, as illustrated on the left side of FIG. 11, even in the pattern-emphasized image g2p obtained by converting the target data piece g4 to decrease the degree of cluster classification, there is a case where no change from the target data piece g4 is observed regarding the black mark. However, even in this case, as illustrated in the center and the right side of FIG. 11, the black mark is elongated and converted between the target data piece g4 and the pattern-emphasized image g1p of the first cluster. Therefore, the display unit 9 can assist the interpretation of the clustering result by facilitating the understanding of the pattern specific to each cluster through the display of the pattern-emphasized image g1p in which the change is observed.

In the second embodiment, the target data piece g4, the pattern emphasis image g1p of the first cluster, and the pattern-emphasized image g2p of the second cluster are displayed, but is not limited thereto. For example, the data conversion unit 8 creates data of each conversion stage by converting the target data in stages to increase the degree of cluster classification in stages and/or to decrease the degree of cluster classification in stages. Note that, as the data of each conversion stage, for example, data created by the gradient ascent method and/or the gradient descent method, data created by a method such as the genetic algorithm, or the like can be applied.

The display unit 9 updates and displays the data of each conversion stage. In this case, the display unit 9 may update and display the data of each conversion stage from the target data piece g4 that is being displayed according to the user's operation to display the pattern-emphasized image g1p of the first cluster. On the contrary, the display unit 9 may update and display the data of each conversion stage from the pattern-emphasized image g1p of the first cluster that is being displayed according to the user's operation to display the target data piece g4. Alternatively, the display unit 9 may update and display the data of each conversion stage from the target data piece g4 that is being displayed according to the user's operation to display the pattern-emphasized image g2p of the second cluster. In addition, the display unit 9 may update and display the data of each conversion stage from the pattern-emphasized image g2p of the second cluster that is being displayed according to the user's operation to display the target data piece g4.

According to such a modification, it is possible to display the data of each conversion stage between the target data and the correction data obtained by converting the target data, so that it is possible to further assist the interpretation of the clustering result. In addition, since the data of each conversion stage is data obtained upon conversion of the target data in stages, it is not necessary to newly create data by complement processing or the like. Therefore, according to the present modification, it is possible to display a state in which the target data gradually changes between the target data and the correction data without performing complement processing between the target data and the correction data.

However, the present modification is not limited thereto, and morphing using complement processing may be executed. At the time of morphing, complement processing among the target data, the data of each conversion stage, and the correction data may be executed. Alternatively, at the time of morphing, complement processing between the target data and the correction data may be executed without using the data of each conversion stage. In any case, the display unit 9 can display a state in which the target data smoothly changes between the target data and the correction data by the morphing.

### Third Embodiment

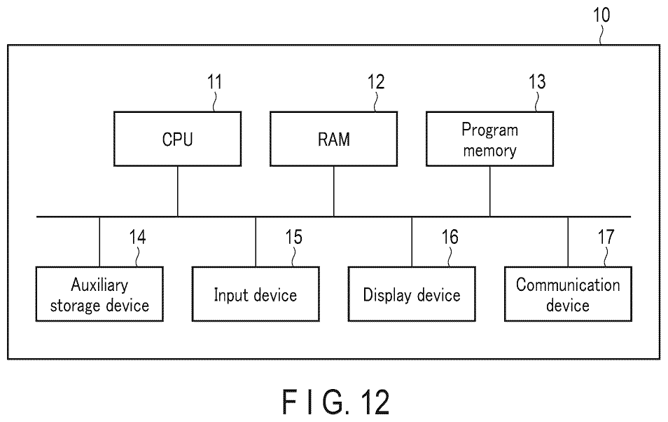

FIG. 12 is a block diagram illustrating an example of a hardware configuration of the clustering apparatus according to a third embodiment. The third embodiment is a specific example of the first and second embodiments, and has a mode in which the clustering apparatus 10 is realized by a computer.

The clustering apparatus 10 includes, as hardware, a central processing unit (CPU) 11, a random access memory (RAM) 12, a program memory 13, an auxiliary storage device 14, an input device 15, a display device 16, and a communication device 17. The CPU 11 communicates with the RAM12, the program memory 13, the auxiliary storage device 14, the input device 15, the display device 16, and the communication device 17 via a bus. That is, the clustering apparatus 10 of the present embodiment is realized by a computer having the above hardware configuration.

The CPU 11 is an example of a general-purpose processor. The RAM12 is used as a working memory by the CPU 11. The RAM12 includes a volatile memory such as a synchronous dynamic random access memory (SDRAM). The program memory 13 stores a program for realizing each function of each unit according to each embodiment in the computer. Furthermore, as the program memory 13, for example, a read-only memory (ROM), a part of the auxiliary storage device 14, or a combination thereof is used. The auxiliary storage device 14 stores data non-temporarily. The auxiliary storage device 14 includes a nonvolatile memory such as a hard disc drive (HDD) or a solid state drive (SSD).

The input device 15 receives inputs of various operations from the user. As the input device 15, a keyboard, a mouse, various switches, a touch pad, a touch panel display, and the like can be used. An electric signal corresponding to the input of the received operation (hereinafter, an operation signal) is supplied to the CPU 11.

The display device 16 displays various data under the control of the CPU 11. As the display device 16, a cathode-ray tube (CRT) display, a liquid crystal display, an organic Electro Luminescence (EL) display, a light-emitting diode (LED) display, a plasma display, or any other display can be appropriately used. The display device 16 is an example of the display unit 9.

The communication device 17 includes a communication interface such as a network interface card (NIC) for performing data communication with various devices connected to the clustering apparatus 10 via a network. Note that an operation signal may be supplied to the clustering apparatus 10 from a computer connected via the communication device 17 or an input device included in the computer, or various data transmitted from the clustering apparatus 10 may be displayed on a display device or the like included in the computer connected via the communication device 17. Note that, in a case where the clustering apparatus 10 is one device including a personal computer or the like, the supply source of the operation signal is the input device 15, and the display destination of various data is the display device 16. Furthermore, in a case where the clustering apparatus 10 is a server apparatus capable of communicating with a client apparatus, the input device 15 can be replaced with a client device connected via the communication device 17 or an input device included in the client device, and the display device 16 can be replaced with a display device or the like included in a client device connected via the communication device 17.

The program stored in the program memory 13 includes a computer-executable instruction. When executed by the CPU 11 which is processing circuitry, the program (computer executable instruction) causes the CPU 11 to execute predetermined processing. For example, when executed by the CPU 11, the program causes the CPU 11 to execute a series of processing described with respect to each of the units 1-8 in FIG. 1 and the units 1-9 in FIG. 9. For example, when executed by the CPU 11, the computer-executable instruction included in the program causes the CPU 11 to execute a method that includes at least a portion of the operations described above. The method may include the steps corresponding to the functions of the units 1-9 described above. A part of the program may include a step of executing a trained model stored in the program memory 13.

The trained model may be, for example, a model that is machine-learned by using teacher data in which input data of a 1024 dimensional vector and a 128 dimensional feature vector based on the input data are associated with each other, and that is for causing a computer to execute processing of calculation of a feature vector based on the input data.

The program or the trained model may be provided to the clustering apparatus 10, which is a computer, in a state of being stored in a computer-readable storage medium. In this case, for example, the clustering apparatus 10 further includes a drive (not illustrated) that reads data from the storage medium, and acquires the program from the storage medium. As the storage medium, for example, a magnetic disk, an optical disk (CD-ROM, CD-R, DVD-ROM, DVD-R, and the like), a magneto-optical disk (MO and the like), a semiconductor memory, or the like can be appropriately used. The storage medium may be referred to as a non-transitory computer readable storage medium. In addition, the program or the trained model may be stored in a server on the communication network, and the clustering apparatus 10 may download the program or the trained model from the server via the communication device 17. Furthermore, the computer executes processing of each of the units 1-9 of the clustering apparatus 10 based on the program stored in the storage medium, and may have any configuration such as a device including one such as a personal computer or a system in which a plurality of devices is connected via the network. In the latter case, for example, the system may have a configuration in which a client apparatus that executes the processing of the display unit 9 illustrated in FIG. 9 is connected via the network to the server apparatus that executes the processing of each of the units 1-8 illustrated in FIG. 1.

The processing circuitry that executes the program or the trained model is not limited to a general-purpose hardware processor such as the CPU 11, and a dedicated hardware processor such as an application specific integrated circuit (ASIC) may be used. The term processing circuitry includes at least one general purpose hardware processor, at least one dedicated hardware processor, and a combination of at least one general purpose hardware processor and at least one dedicated hardware processor. In the example illustrated in FIG. 12, the CPU 11, the RAM 12, and the program memory 13 correspond to the processing circuitry.

According to at least one of the embodiments described above, it is possible to assist the interpretation of the clustering result. The same applies to at least one of the modifications described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A clustering apparatus comprising:
processing circuitry configured to:
acquire input data;
calculate a feature vector from the input data;
divide the input data into two or more clusters based on the feature vector;
select a first cluster from the two or more clusters;
select a second cluster different from the first cluster from the two or more clusters;
extract target data from the input data;
calculate a degree of cluster classification indicating an index by which the target data is classified into the first cluster or the second cluster based on the target data, the first cluster, and the second cluster; and
convert the target data based on the degree of cluster classification.

2. The clustering apparatus according to claim 1, wherein
the processing circuitry is configured to extract the target data by performing selection from or combination of the input data.

3. The clustering apparatus according to claim 1, wherein
the processing circuitry is configured to extract the target data by performing selection from or combination of input data of the first cluster or the second cluster.

4. The clustering apparatus according to claim 1, wherein
the processing circuitry is configured to extract the target data by combining input data of each of the first cluster and the second cluster.

5. The clustering apparatus according to claim 1, wherein
the degree of cluster classification represents a difference between a distance from the target data to a representative vector of the first cluster and a distance from the target data to a representative vector of the second cluster.

6. The clustering apparatus according to claim 1, wherein
the degree of cluster classification represents projection of the target data onto a direction vector from a representative vector of the first cluster to a representative vector of the second cluster.

7. The clustering apparatus according to claim 1, wherein
the degree of cluster classification represents a cosine of an angle between the target data and a representative vector of the first cluster with a midpoint between the representative vector of the first cluster and a representative vector of the second cluster as an origin.

8. The clustering apparatus according to claim 5, wherein
the representative vector of the first cluster is an average of feature vectors of input data belonging to the first cluster, and
the representative vector of the second cluster is an average of feature vectors of input data belonging to the second cluster.

9. The clustering apparatus according to claim 5, wherein
the representative vector of the first cluster is an average of feature vectors of a subset of input data belonging to the first cluster, and
the representative vector of the second cluster is an average of feature vectors of a subset of input data belonging to the second cluster.

10. The clustering apparatus according to claim 5, wherein
the representative vector of the first cluster is a feature vector of input data closest to an average of the first cluster, and
the representative vector of the second cluster is a feature vector of input data closest to an average of the second cluster.

11. The clustering apparatus according to claim 1, wherein
the processing circuitry is configured to convert the target data to increase and/or decrease the degree of cluster classification.

12. The clustering apparatus according to claim 11, wherein
the processing circuitry is configured to:
add a differential of the degree of cluster classification with respect to the target data iteratively to the target data, in a case where the target data is converted to increase the degree of cluster classification, and
subtract the differential of the degree of cluster classification with respect to the target data iteratively from the target data, in a case where the target data is converted to decrease the degree of cluster classification.

13. The clustering apparatus according to claim 11, wherein
the processing circuitry is configured to perform:
(a) processing of randomly converting the target data to create a plurality of pieces of data;
(b) processing of randomly converting, among the plurality of pieces of data, data having a large degree of cluster classification and data having a small degree of cluster classification to create the plurality of pieces of data; and
(c) processing of converting the target data by recursively repeating the processing (b).

14. The clustering apparatus according to claim 11, further comprising:
a display that displays the target data, the data obtained by converting the target data to increase the degree of cluster classification, and the data obtained by converting the target data to decrease the degree of cluster classification.

15. The clustering apparatus according to claim 11, further comprising a display, wherein
the processing circuitry is configured to convert the target data in stages to generate data of each conversion stage to increase the degree of cluster classification in stages and/or decrease the degree of cluster classification in stages, and
the display updates and displays the data at each of the stages of conversion.

16. The clustering apparatus according to claim 1, wherein
the processing circuitry is configured to output an element of the target data in which the degree of cluster classification greatly changes in a case where the target data is perturbed.

17. The clustering apparatus according to claim 16, wherein
the processing circuitry is configured to output a size of each element of a gradient vector of the degree of cluster classification with respect to the target data.

18. The clustering apparatus according to claim 16, wherein
the processing circuitry is configured to output a size of each element of a gradient vector of the degree of cluster classification and a difference between adjacent elements of the target data with respect to the target data.

19. A method comprising:
acquiring, by the processing circuitry, input data;
calculating, by the processing circuitry, a feature vector from the input data;
dividing, by the processing circuitry, the feature vector into two or more clusters;
selecting, by the processing circuitry, a first cluster from the two or more clusters;
selecting, by the processing circuitry, a second cluster different from the first cluster from the two or more clusters;
extracting, by the processing circuitry, target data from the input data;
calculating, by the processing circuitry, a degree of cluster classification indicating an index by which the target data is classified into the first cluster or the second cluster based on the target data, the first cluster, and the second cluster; and
converting, by the processing circuitry, the target data based on the degree of cluster classification.

20. A non-transitory computer readable storage medium including computer executable instructions, wherein the instructions, when executed by a processor, cause the processor to perform a method comprising:
acquiring input data;
calculating a feature vector from the input data;
dividing the feature vector into two or more clusters;
selecting a first cluster from the two or more clusters;
selecting a second cluster different from the first cluster from the two or more clusters;
extracting target data from the input data;
calculating a degree of cluster classification indicating an index by which the target data is classified into the first cluster or the second cluster based on the target data, the first cluster, and the second cluster; and
converting the target data based on the degree of cluster classification.
